(19) United States
(12) Patent Application Publication
(10) Pub. No.: US 2021/0013659 A1
(43) Pub. Date: Jan. 14, 2021

(54) Method for Establishing a Connection, and Arrangement

(71) Applicant: ZF Friedrichshafen AG, Friedrichshafen (DE)

(72) Inventors: Markus Moosmann, Grünkraut (DE); Florian Pawlak, Friedrichshafen (DE); Tobias Nusser, Friedrichshafen (DE); Karlheinz Mayr, Bregenz (AT); Thilo Schmidt, Meckenbeuren (DE)

(21) Appl. No.: 16/980,695

(22) PCT Filed: Feb. 15, 2019
(86) PCT No.: PCT/EP2019/053771

§ 371 Date: Sep. 14, 2020

(30) Foreign Application Priority Data
Mar. 15, 2018 (DE) 10 2018 203 991.7

(51) Int. Cl. H01R 13/33; H01R 13/26; H01R 13/627; H01R 13/52

(52) U.S. Cl. CPC H01R 13/33; H01R 13/26; F16K 31/0675; H01R 13/521; H01R 2201/22; H01R 13/6272

(57) ABSTRACT

A plug element (10) includes a housing (10a, 10b) and two contact spring wires (17a, 18a) arranged and fixed in the housing (10a, 10b). The housing (10a, 10b) includes laterally arranged openings (25, 26), and the contact spring wires (17a, 18a) form spring pressure contacts (17a, 18a) in the area of the lateral openings (25, 26).

### CROSS-REFERENCE TO RELATED APPLICATION

The present application is related and has right of priority to International Application No. PCT/EP2019/053771 filed on Feb. 15, 2019 and published as WO 2019/174853 and also to German Patent Application No. 10 2018 203 991.7 filed on Mar. 15, 2018, both of which are incorporated by reference in their entirety for all purposes.

### FIELD OF THE INVENTION

The invention relates generally to a device for establishing an electrical connection and a mechanical connection to an actuator. The invention also relates to an arrangement for establishing an electrical connection and a mechanical connection between the actuator and a device.

### BACKGROUND

DE 103 37 197 A1 describes an arrangement for the electrical contacting of a solenoid valve, which includes contact elements arranged in a contact housing and which are contacted to a printed circuit plate arranged on a carrier element. The printed circuit plate includes counter-contact elements, which, together with the contact elements of the solenoid valve, form pressure contacts. In the carrier element, groove-shaped recesses are provided, into which the face ends of the valve housing engage, whereby a labyrinth sealing is formed, which is to prevent the penetration of dirt particles, in particular metal chips, into the contact housing.

### SUMMARY OF THE INVENTION

Example aspects of the invention establish an electrical connection and a mechanical connection to an actuator, preferably a hydraulic control unit.

According to a first example aspect of the invention, in order to establish the electrical connection to an actuator, a plug element is provided, which includes a housing and two contact spring wires arranged and fixed in the housing. The housing includes openings arranged on the side, and the contact spring wires form spring pressure contacts in the area of the lateral openings. The contact spring wires extend out of the housing, in the area of the lateral openings, as elastically deformable arches and are contactable to appropriate counter-contacts with the aid of a plug-in movement. The actuator is preferably a solenoid valve, for example, for a hydraulic control unit.

According to one preferred example embodiment, the contact spring wires are connected to electrical leads, which extend to a printed circuit plate. In certain installation situations, individual actuators are positioned differently, i.e., arranged at different distances from the printed circuit plate. The plug element is particularly suitable for this case, since the lengths of the electrical leads can be adapted to the different distances.

According to one further preferred example embodiment, the plug element has a longitudinal or plug-in axis, which corresponds to the plug-in direction during the establishment of the electrical and mechanical connections. The pressure direction of the two electrical spring pressure contacts extends essentially perpendicularly to the longitudinal axis of the plug element and in the same plane. Therefore, the advantage of a flat design for the plug element is achieved.

According to one further preferred example embodiment, the plug element includes detent or snap-in elements, i.e., the plug element can be mechanically connected to the actuator with the aid of one simple plug-in movement, without further aids. Simultaneous with the mechanical connection, i.e., a snap-in or detent connection, the electrical contact is established via spring pressure.

According to one further preferred example embodiment, the plug element includes two housing halves, which can be joined to each other and in which the two contact spring wires are accommodated and fixed in a form-locking manner. Preferably, the two housing halves are designed as plastic injection-molded parts including preformed recesses or indentations for the contact spring wires. Since the contact spring wires are arranged next to each other in the same plane between the housing halves, a flat design results for the entire housing.

According to one further preferred example embodiment, a labyrinth sealing, which extends in the longitudinal direction of the plug element, is arranged between the laterally arranged electrical contacts. The labyrinth sealing prevents conductive particles, for example, metal chips floating in the transmission oil, from traveling from one contact side to the other contact side and, therefore, establishing an electrically conductive bridge, which could result in a short circuit.

According to one further preferred example embodiment, the labyrinth sealing is designed, on the one hand, as a groove-shaped recess or groove and, on the other hand, as a ridge engaging into the groove. Therefore, an effective seal results, which is integrated into the plug element and gets by without additional sealing elements. Preferably, the continuous labyrinth sealing is arranged in the center between the two contact spring wires positioned inversely with respect to one another, which are therefore electrically insulated with respect to each other.

According to one further example aspect of the invention, it is provided, with respect to an arrangement for the electrical and mechanical connection between an actuator and the above-described plug element, that the actuator includes, on a face end of the actuator, a contact housing into which the plug element is insertable and fixed. The plug-in direction extends transversely to the longitudinal axis of the actuator. A flat contact housing results, which requires little installation space. The plug element including the connected electrical leads bridges the spatial separation that exists between the actuator and the printed circuit plate due to the installation situation.

According to one further preferred example embodiment, the connection contacts of the actuator are designed as contact pins arranged on the face end, which are contacted by the spring pressure contacts of the plug element. The transversely acting contact pressures or forces are absorbed by the contact pins.

According to one further preferred example embodiment, the contact housing includes mechanical connecting elements designed as detent or snap-in elements, which correspond to the detent or snap-in elements of the plug element. As a result, the plug element can be mechanically connected and electrically contacted to the actuator with the aid of a detent or snap-in connection.

According to one further preferred example embodiment, labyrinth sealings are arranged between the contact housing and the plug element, which are preferably designed as ridges and grooves and form one further debris guard on the outer side of the plug element.

According to one further preferred example embodiment, the device and/or the arrangement are/is utilized for establishing an electrical connection and a mechanical connection to the actuator for a transmission control unit of a vehicle transmission. The transmission can therefore be any type of vehicle transmission that includes such an actuator and such a transmission control unit. Such a vehicle transmission is, in particular, an automatic transmission or an automated transmission. This also includes a dual clutch transmission or a transmission including a hydrodynamic torque converter or a mixed form thereof, or a hydrostatic transmission. The vehicle transmission can even be a transfer gearbox, however, such as a transfer gearbox, for example, of an all-wheel drive train for a motor vehicle, or the vehicle transmission can even be a reversing gearbox for a rail vehicle.

### BRIEF DESCRIPTION OF THE DRAWINGS

Exemplary embodiments of the invention are represented in the drawing and are described in greater detail in the following, wherein further features and/or advantages can result from the description and/or the drawing. Wherein

FIG. 1 shows a first exemplary embodiment of the invention for a plug element including connecting lines;

FIG. 2 shows single parts of the plug element according to FIG. 1;

FIG. 3 shows an electrical and mechanical connection between the plug element and an actuator;

FIG. 4 shows a second exemplary embodiment of the invention for a modified plug element;

FIG. 5 shows single parts of the plug element according to FIG. 4; and

FIG. 6 shows an arrangement for the electrical and mechanical connection between the plug element and an actuator.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

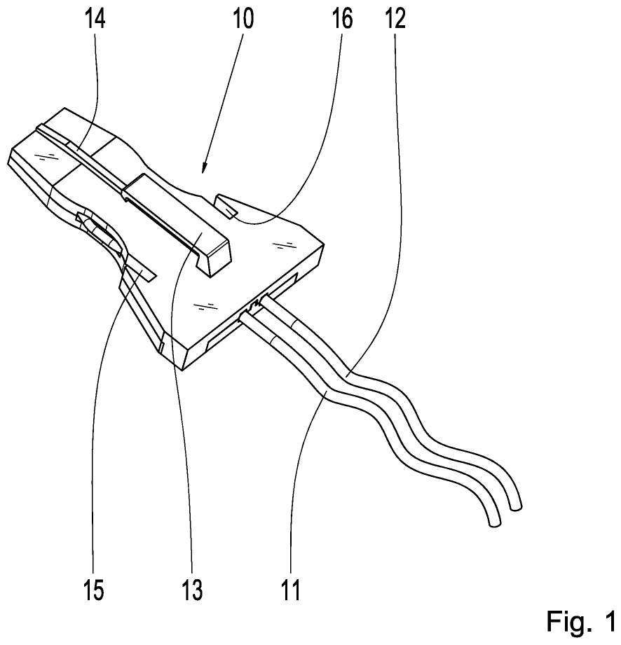

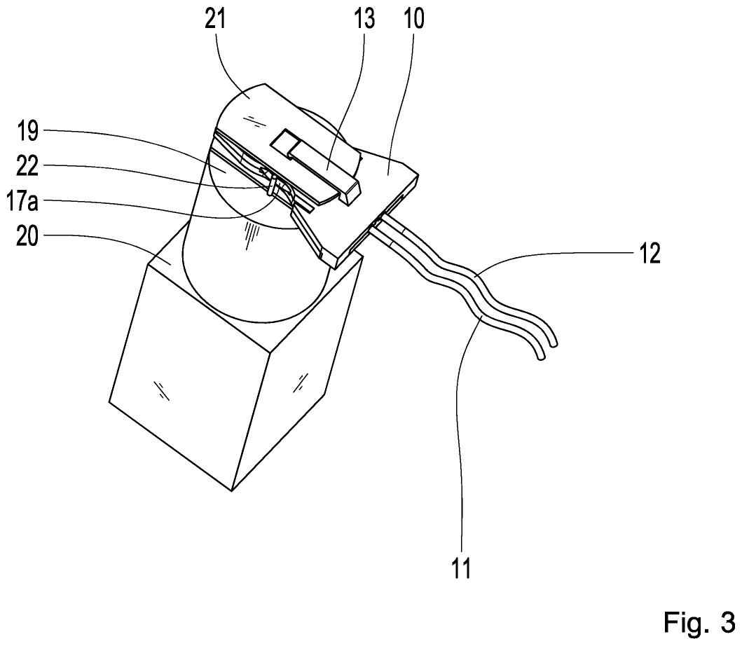

FIG. 1 shows, as a first exemplary embodiment of the invention, a plug element 10, which is provided for an electrical contacting of an actuator (not represented here), preferably of a hydraulic control unit of a transmission for motor vehicles. The plug element 10 includes two connecting lines 11, 12 of any length, which can be connected, at the ends, to an electronic connecting arrangement (not represented), in particular a printed circuit plate of an electronic transmission control unit. The plug element 10 is provided for actuators, which are arranged at a greater spatial distance with respect to the printed circuit plate. A retaining clamp 13, also referred to as a detent lug 13, for fixing the plug element 10 with respect to a contact housing 21 (FIG. 3) is arranged on the top side of the plug element 10, which is visible in the drawing. Moreover, a ridge 14 is arranged on the top side of the plug element 10, which is part of a labyrinth sealing and engages into a groove (not represented) in the contact housing 21 (FIG. 3). The plug element 10 further includes lateral guide slots 15, 16, which are utilized for the longitudinal guidance and fixing of the plug element 10 with respect to the contact housing 21 (FIG. 3).

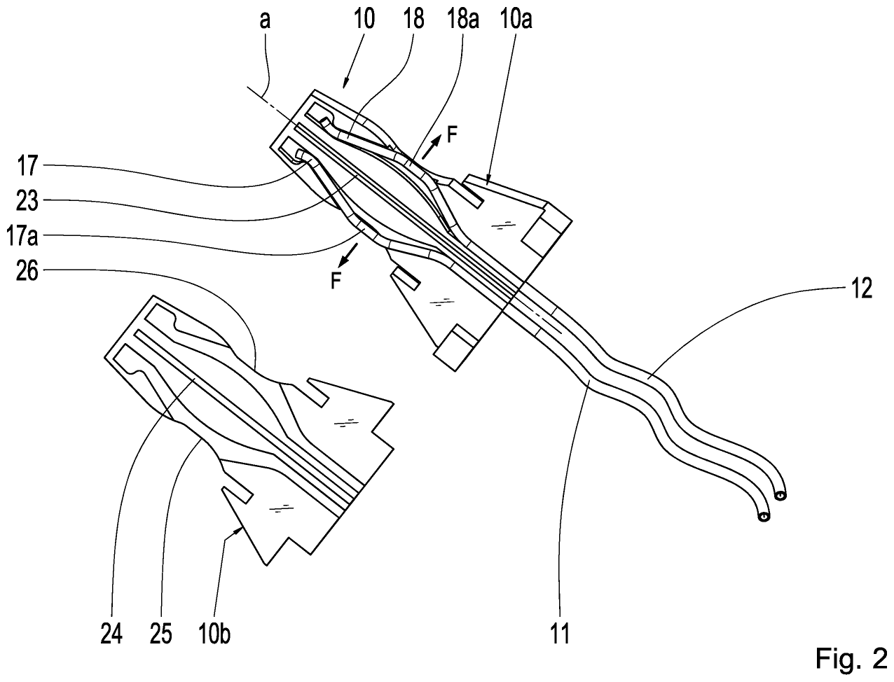

FIG. 2 shows the plug element 10 including parts of the plug element 10, namely a first housing half 10a, a second housing half 10b, and contact spring wires 17, 18, which form spring-loaded, outwardly extending spring pressure contacts 17a, 18a. The plug element 10 has a longitudinal or plug-in axis a and is inserted in the direction of the plug-in axis a into the contact housing 21 (FIG. 3). The pressure direction of the spring pressure contacts 17a, 18a, which are designed as arched bending springs, is marked by arrows F, i.e., transversely to the longitudinal axis a. For this purpose, the two housing halves 10a, 10b include lateral openings 25, 26. The contact spring wires 17, 18, which are accommodated by the two housing halves 10a, 10b in indentations (without a reference number) in a form-locking manner, are electrically conductively connected to the connecting lines 11, 12.

FIG. 3 shows the connection of the plug element 10 to an actuator 19, which is arranged on a housing 20, preferably a hydraulic control unit 20. On the face end of the actuator 19, preferably a solenoid valve 19, a contact housing 21 is arranged, which partially accommodates the plug element 10, wherein the plug element 10 is secured in position in the longitudinal direction by the lockable retaining clamp 13. The actuator 19 includes two contact pins, of which only the contact pin 22 is visible; the contact pin 22 is in pressure contact with the electrical contact 17a.

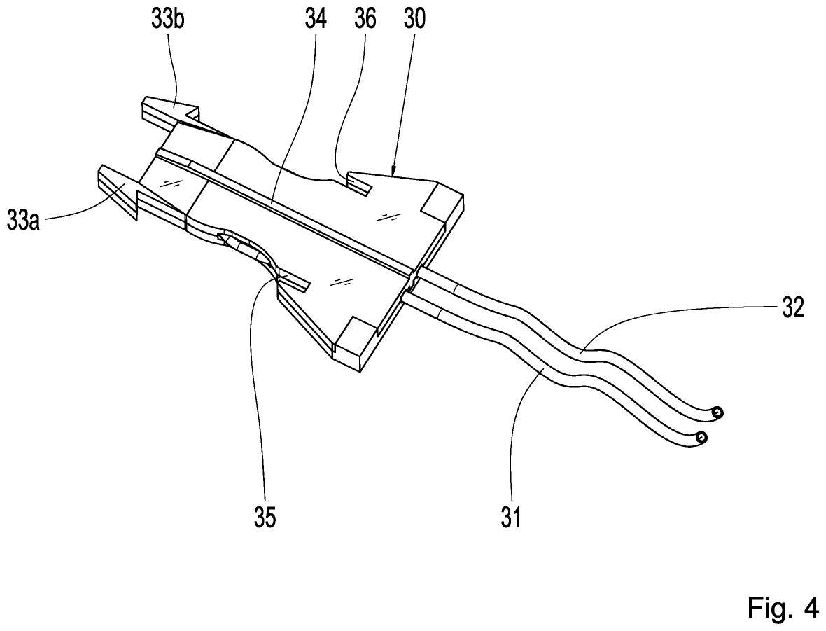

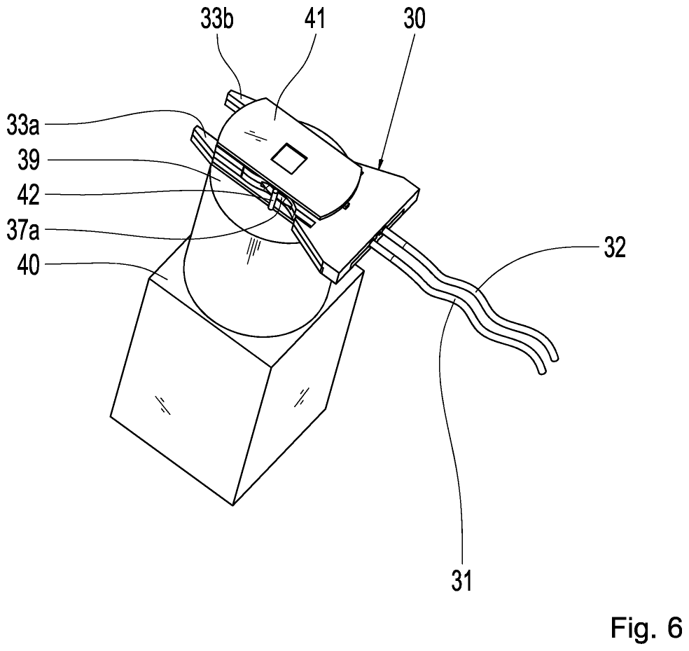

FIG. 4 shows a second exemplary embodiment of the invention for a plug element 30 including connecting lines 31, 32. A ridge 34 for a labyrinth sealing with respect to the contact housing 41 (FIG. 6) is arranged on the outer side of the plug element 30. Detent or snap-in elements 33a, 33b are provided on the plug element 30, on the face end, for the fixation in the longitudinal direction. Moreover, the plug element 30 include guide slots 35, 36 for a guidance and fixation on the contact housing 41 (FIG. 6).

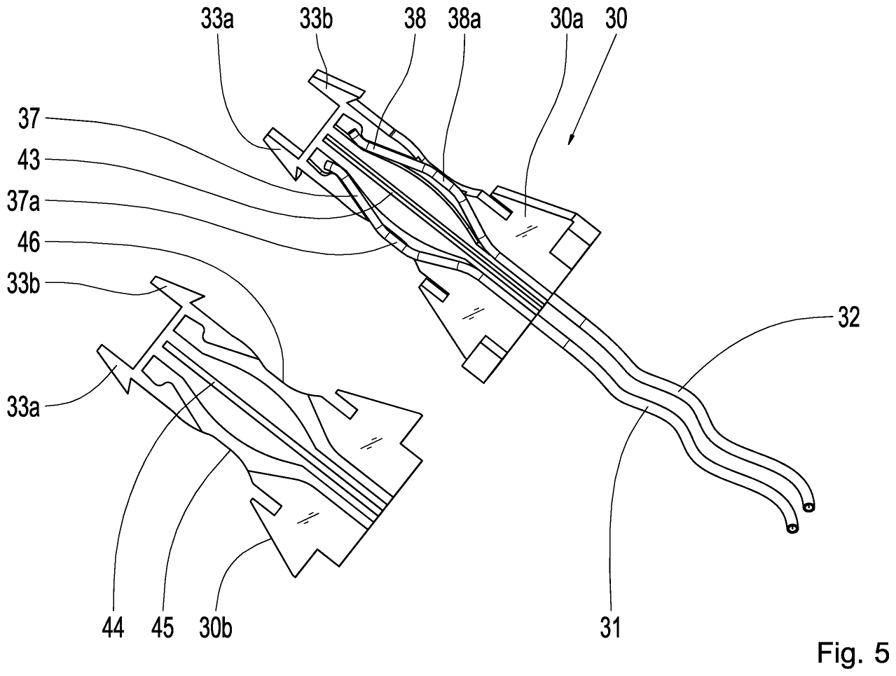

FIG. 5 shows parts of the plug element 30, namely a first housing half 30a, a second housing half 30b, and two contact spring wires 37, 38, which form electrical contacts designed as spring pressure contacts 37a, 38a and are electrically conductively connected to the connecting lines 31, 32. The first housing half 30a includes a ridge 43 arranged centrally between the contact spring wires 37, 38, while the second housing half 30b includes a corresponding groove 44. The ridge 43 and the groove 44 form a labyrinth sealing as a debris guard. The two housing halves 30a, 30b include detent elements 33a, 33b and lateral openings 45, 46 for the spring pressure contacts 37a, 38a.

FIG. 6 shows the connection of the plug element 30 including the contact housing 41 of the actuator 39, which is arranged on a housing 40. The detent lugs 33a, 33b are locked with respect to the face ends of the contact housing 41 and bring about a fixation of the plug element 30 in the longitudinal or plug-in direction. The connection contact of the actuator 39, which is designed as a contact pin 42, is contacted by the spring pressure contact 37a. The compressive forces resulting from the spring pressure contacts transversely to the longitudinal direction of the plug element 30 are therefore absorbed by the two contact pins.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE SIGNS

10 plug element
10a first housing half
10b second housing half
11 connecting line
12 connecting line
13 retaining clamp/detent element
14 ridge (external)
15 guide slot
16 guide slot
17 first contact wire
17a electrical contact
18 second contact wire
18a electrical contact
19 actuator
20 housing
21 contact housing
22 contact pin
23 ridge (internal)
24 groove
25 lateral opening
26 lateral opening
30 plug element
30a first housing half
30b second housing half
31 connecting line
32 connecting line
33a detent element
33b detent element
34 ridge
35 guide slot
36 guide slot
37 first contact wire
37a electrical contact
38 second contact wire
38a electrical contact
39 actuator
40 housing
41 contact housing
42 contact pin
43 ridge (internal)
44 groove
45 lateral opening
46 lateral opening
a longitudinal or plug-in axis
F pressure direction

1-11. (canceled)

12. A device for establishing an electrical connection and a mechanical connection to an actuator (19, 29) for a transmission control unit of a transmission, comprising a plug element (10, 20) that comprises a housing (10a, 10b, 20a, 20b) and a pair of contact spring wires (17a, 18a, 27a, 28a) arranged and fixed in the housing (10a, 10b, 20a, 20b),
wherein the housing (10a, 10b, 20a, 20b) comprises a pair of laterally arranged openings (25, 26, 45, 46), and each of the contact spring wires (17a, 18a, 27a, 28a) forms a spring pressure contact (17a, 18a, 27a, 28a) proximate a respective one of the lateral openings (25, 26, 45, 46).

13. The device of claim 12, wherein each of the contact spring wires (17a, 18a, 27a, 28a) is connected to a respective electrical lead (11, 12).

14. The device of claim 12, wherein the plug element (10, 20) has a longitudinal or plug-in axis (a) and a pressure direction (F) of the electrical spring pressure contacts (17a, 18a, 27a, 28a) extends essentially perpendicularly to the longitudinal axis (a).

15. The device of claim 12, wherein the plug element (10, 30) comprises detent or snap-in elements (13, 33a, 33b).

16. The device of claim 12, wherein the housing (10a, 10b, 20a, 20b) comprises two housing halves (10a, 10b, 30a, 30b), which are joinable to each other and between which the contact spring wires (17, 18, 37, 38) are accommodated and fixed.

17. The device of claim 12, wherein a continuous labyrinth sealing (23, 24, 43, 44) is arranged between the contact spring wires (17, 18, 37, 38).

18. The device of claim 17, wherein the labyrinth sealing is a continuous groove (24, 44) and a ridge (23, 43) engaging into the groove (24, 44).

19. An arrangement for establishing an electrical connection and a mechanical connection between an actuator (19, 39), comprising electrical connection contacts (22, 42) and the device of claim 12, wherein the actuator (19, 39) comprises a contact housing (21, 41) on a face end of the actuator (19, 39), the plug element (10, 30) insertable into and fixable within the contact housing (21, 41).

20. The arrangement of claim 19, wherein the electrical connection contacts of the actuator (19, 39) are configured as contact pins (22, 42), which form contacts together with the spring pressure contacts (17a, 18a, 37a, 38a) of the plug element (10, 30).

21. The arrangement of claim 19, wherein the contact housing (21, 41) comprises detent or snap-in elements, which correspond to detent or snap-in elements (13, 33a, 33b) of the plug element (10, 30).

22. The arrangement of claim 19, wherein labyrinth sealings (14, 34) are arranged between the contact housing (21, 41) and the plug element (10, 30).
